(19) United States
(12) Patent Application Publication
(10) Pub. No.: US 2014/0061444 A1
(43) Pub. Date: Mar. 6, 2014

(54) Proximity Sensor Package and Packing Method Thereof

(71) Applicant: uPI Semiconductor Corp., Zhubei City (TW)

(72) Inventors: Kun-Chang Wang, Zhubei City (TW); Ping-Yuan Lin, Zhubei City (TW)

(73) Assignee: uPI Semiconductor Corp., Zhubei City (TW)

(21) Appl. No.: 14/018,530

(22) Filed: Sep. 5, 2013

(30) Foreign Application Priority Data
Sep. 6, 2012 (TW) 101132484

(51) Int. Cl. G01S 17/02

(52) U.S. Cl. CPC G01S 17/026
USPC 250/214.1; 250/221; 29/825

(57) ABSTRACT

A proximity sensor package and a packaging method thereof are disclosed. The proximity sensor package includes a light emitting unit and a light sensor. The light sensor has a first surface having a light sensing area. The light emitting unit is disposed on the first surface of the light sensor outside the light sensing area.

### BACKGROUND OF THE INVENTION

1. Field of the Invention

The invention relates to a proximity sensor; in particular, to a proximity sensor package and a packaging method thereof.

2. Description of the Prior Art

As the name implies, a proximity sensor senses optically whether there is an object or obstacle in front. In practical applications, the proximity sensor can be used in a smart phone or handheld device to determine whether the user is close by to answer, or used in a domestic robot to determine whether any furniture or person is in front. Please refer to FIG. 1. FIG. 1 illustrates a cross-sectional schematic diagram of a packaging object structure of a conventional proximity sensor.

As shown in FIG. 1, the conventional proximity sensor package 1 includes a light emitting unit 10, a light receiving unit 12, a molding compound 14, and a substrate 16. After a light L from the light emitting unit 10 is emitted out through a hole H1 and meets an obstacle, a part of the light L will be reflected by the obstacle and transmitted to a light sensing area SA on the light receiving unit 12 through a hole H2. Then, the proximity sensor can determine whether the obstacle is in front according to the reflected light R received by the light receiving unit 12 and react accordingly.

However, the semiconductor manufacturing processes used to produce the LED of the light emitting unit 10 and the processes to produce the semiconductor of the light sensor on the light receiving unit 12 are totally different. The LED is produced by the III-V semiconductor manufacturing process, and the light receiving unit 12 is produced by the silicon manufacturing process. Therefore, it is hard to combine these two different manufacturing processes together. As shown in FIG. 1, in the conventional proximity sensor package 1, the light emitting unit 10 and the light receiving unit 12 are arranged side by side; therefore, the conventional proximity sensor package 1 is in a strip form. In addition, in the conventional proximity sensor package 1, the light emitting unit 10 and the light receiving unit 12 are approximately at the same horizontal height. In order to prevent noise cross-talk, even though the molding compound 14 can be formed by light-blocking material, a distance d is still necessary between the light emitting unit 10 and the light receiving unit 12. However, this will also make it difficult to reduce the volume of the conventional proximity sensor package 1, and seriously affect its applicability in handheld electronic devices.

Therefore, the invention provides a proximity sensor package and a packaging method thereof to solve the above-mentioned problems occurred in the prior arts.

### SUMMARY OF THE INVENTION

A scope of the invention is to provide a proximity sensor package. In a preferred embodiment, the proximity sensor package includes a light emitting unit and a light sensor. The light sensor has a first surface having a light sensing area. The light emitting unit is disposed on the first surface of the light sensor outside the light sensing area.

In an embodiment, the proximity sensor package further includes a barrier. The barrier is disposed on the first surface and between the light emitting unit and the light sensing area.

In an embodiment, the barrier is a die.

In an embodiment, the light emitting unit is disposed on an adhering area of the first surface of the light sensor.

In an embodiment, the light sensor further includes a control circuit used for controlling the operation of the light sensor and the light emitting unit.

In an embodiment, the light sensor further includes a control circuit and the adhering area has a metal layer. A pin of the light emitting unit is electrically connected to the control circuit through the metal layer.

In an embodiment, the light sensor and the light emitting unit are dies.

In an embodiment, a lens set or a curved hole structure is disposed above the light emitting unit.

In an embodiment, the proximity sensor package further includes a molding compound used to mold the light sensor and the light emitting unit to form the proximity sensor package.

In an embodiment, a light emitting surface of the light emitting unit and the light sensing area on the light sensor are located on different planes respectively.

Another scope of the invention is to provide a packaging method for a proximity sensor package. In a preferred embodiment, the packaging method includes the steps of: (a) providing a light sensor having a first surface having a light sensing area; (b) disposing a light emitting unit on the first surface of the light sensor outside the light sensing area.

Compared to the prior arts, in the proximity sensor package and packaging method thereof of the invention, a metal layer is disposed on the upper surface of the light sensor, so that the pin of the light emitting unit can be electrically connected to the control circuit through the metal layer to effectively reduce the volume of the entire proximity sensor package. In addition, since the light emitting surface of the light emitting unit and the light sensing area on the light sensor are located on different planes respectively, and furthermore a barrier is disposed between the light emitting unit and the light sensing area, the cross-talk generated by scattering the lights of the light emitting unit to the light sensing area on the light sensor can be effectively prevented, so that the proximity sensor will not malfunction due to misjudgment.

The advantage and spirit of the invention may be understood by the following detailed descriptions together with the appended drawings.

### BRIEF DESCRIPTION OF THE APPENDED DRAWINGS

FIG. 1 illustrates a cross-sectional schematic diagram of a packaging object structure of a conventional proximity sensor.

FIG. 2 illustrates a cross-sectional schematic diagram of a proximity sensor package in an embodiment of the invention.

FIG. 3 illustrates a cross-sectional schematic diagram of the proximity sensor package further including a barrier.

FIG. 4 illustrates a cross-sectional schematic diagram of the proximity sensor package further including a lens set.

FIG. 5 illustrates a cross-sectional schematic diagram of the proximity sensor package further including a curved hole structure.

FIG. 6 illustrates a flowchart of the packaging method for the proximity sensor package in another embodiment of the invention.

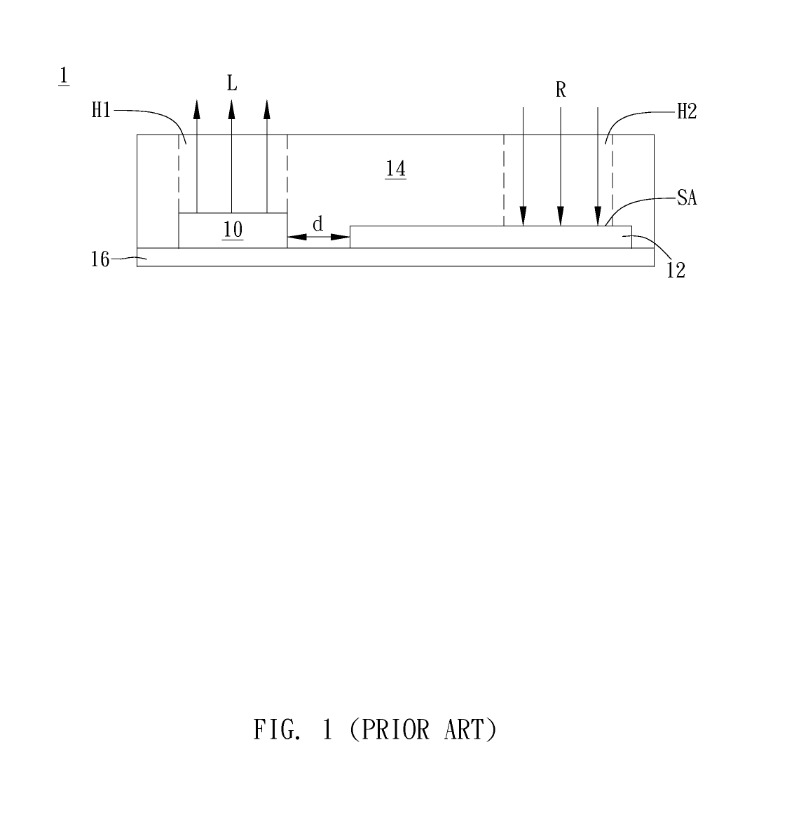

### DETAILED DESCRIPTION OF THE INVENTION

A preferred embodiment of the invention is a proximity sensor package. In practical applications, the proximity sensor can sense optically whether an object or an obstacle is in front; therefore, it can be used in a smart phone or handheld device to determine whether the user is close by to answer, or used in a domestic robot to determine whether any furniture or person is in front. The invention can effectively reduce the volume of the entire proximity sensor package and prevent the cross-talk generated by scattering the lights of the light emitting unit to the light sensing area on the light sensor at the same time.

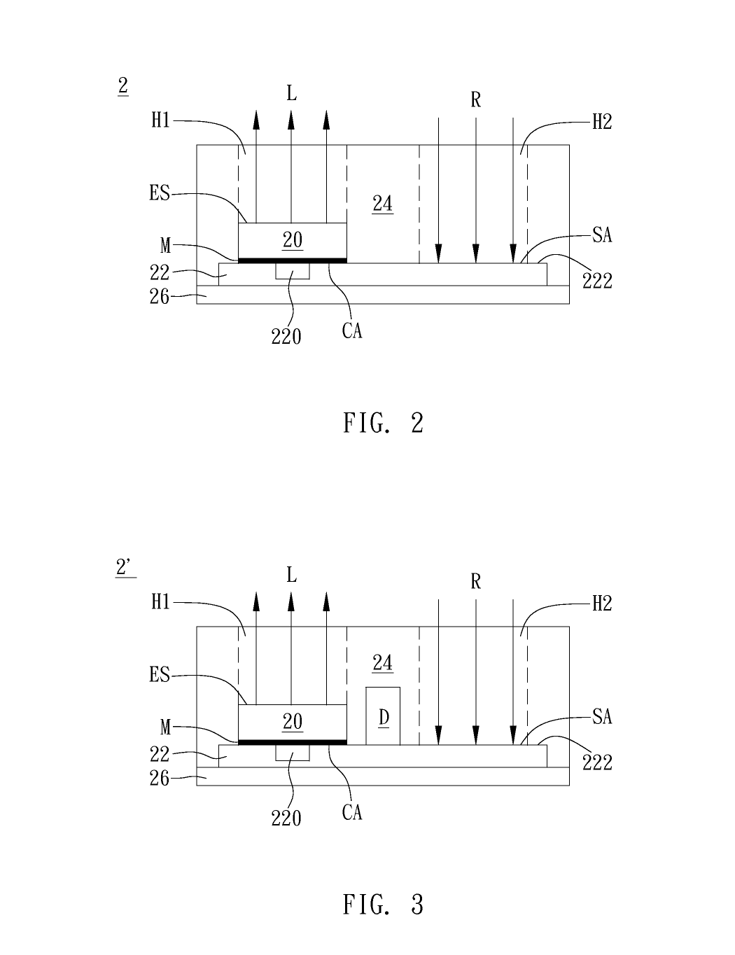

Please refer to FIG. 2. FIG. 2 illustrates a cross-sectional schematic diagram of the proximity sensor package in this embodiment. As shown in FIG. 2, the proximity sensor package 2 includes a light emitting unit 20, a light sensor 22, a packaging molding compound 24, a substrate 26, a first hole H1, and a second hole H2. The light sensor 22 includes a control circuit 220. A first surface (the upper surface) 222 of the light sensor 22 has a light sensing area SA. The light sensor 22 is disposed on the substrate 26. The light emitting unit 20 is disposed on the first surface 222 of the light sensor 22 outside the light sensing area SA. The light emitting unit 20 can be a light-emitting diode (LED) for emitting a light L, but not limited to this.

It should be noted that the control circuit 220 is used to control the operation of the light emitting unit 20 and the light sensor 22. In fact, the control circuit 220 can be integrated with the light sensor 22 or separately disposed outside the light sensor 22, but not limited to this. In more details, whether the light emitting unit 20, the light sensor 22, and the control circuit 220 are three different dies, or the light sensor 22 and the control circuit 220 are integrated in the same die, the control circuit 220 can control the operation of the light emitting unit 20 and the light sensor 22.

A light-blocking material can be used as the molding compound 24 to mold the light emitting unit 20 and the light sensor 22, and the first hole H1 and the second hole H2 corresponding to the light emitting unit 20 and the light sensor 22 respectively are formed on the molding compound 24, so that the light emitting unit 20 can emit the light L through the first hole H1 and the light sensor 22 can receive a reflected light R through the second hole H2.

In this embodiment, the first surface 222 of the light sensor 22 has an adhering area CA, and the adhering area CA has a metal layer M. Therefore, a pin of the light emitting unit 20 can be electrically connected to the control circuit 220 of the light sensor 22 through the metal layer M. In fact, the metal layer M on the adhering area CA of the first surface 222 of the light sensor 22 can be formed in a specific layout method, such as the auto place and route (APR) method usually used in the circuit layout field. In this method, the layout of the light sensor 22 is designed with one less metal layer for routing, so that all APR regions can be designed as the adhering area CA.

By doing so, the difficulty in prior art regarding integrating the III-V semiconductor manufacturing process used to produce the LED and the silicon manufacturing process used to produce the light receiving unit can be solved. Therefore, it is unnecessary to arrange the light emitting unit 20 and the light receiving unit 22 side by side in prior art; instead, the light emitting unit 20 of the invention can be integrated above the light receiving unit 22 to greatly reduce the volume of the proximity sensor package 2.

In addition, as shown in FIG. 2, a light emitting surface ES of the light emitting unit 20 and the light sensing area SA on the light sensor 22 are located on different planes respectively; therefore, the light L emitted from the light emitting surface ES of the light emitting unit 20 is hard to be refracted to the light sensing area SA on the light sensor 22, so that the malfunction due to noise interference in prior art can be prevented.

Although the packaging molding compound 24 of FIG. 2 is formed by the light-blocking material and the cross-talk generated by scattering the lights L of the light emitting unit 20 to the light sensing area SA on the light sensor 22 can be reduced, in order to enhance light-blocking effect to increase the accuracy of the proximity sensor, some auxiliary unit can be added in the proximity sensor package structure, such as a barrier, a lens set, or a curved hole structure which will be introduced respectively as follows.

Please refer FIG. 3. FIG. 3 illustrates a cross-sectional schematic diagram of the proximity sensor package 2′ further including the barrier D. As shown in FIG. 3, the barrier D is disposed on the first surface 222 of the light sensor 22 and between the light emitting unit 20 and the light sensing area SA. The functions of the barrier D in this embodiment includes: (1) preventing the cross-talk generated by scattering the lights L of the light emitting unit 20 to the light sensing area SA on the light sensor 22; and (2) separating the molding on the light emitting unit 20 and the molding on the light sensing area SA to prevent the connection between them which might result in misjudgment by the light sensor 22. In practical applications, the barrier D can be formed by a semiconductor die, such as a dummy die or other light-blocking materials, and the height and width of the barrier D can be adjusted based on practical needs without specific limitations.

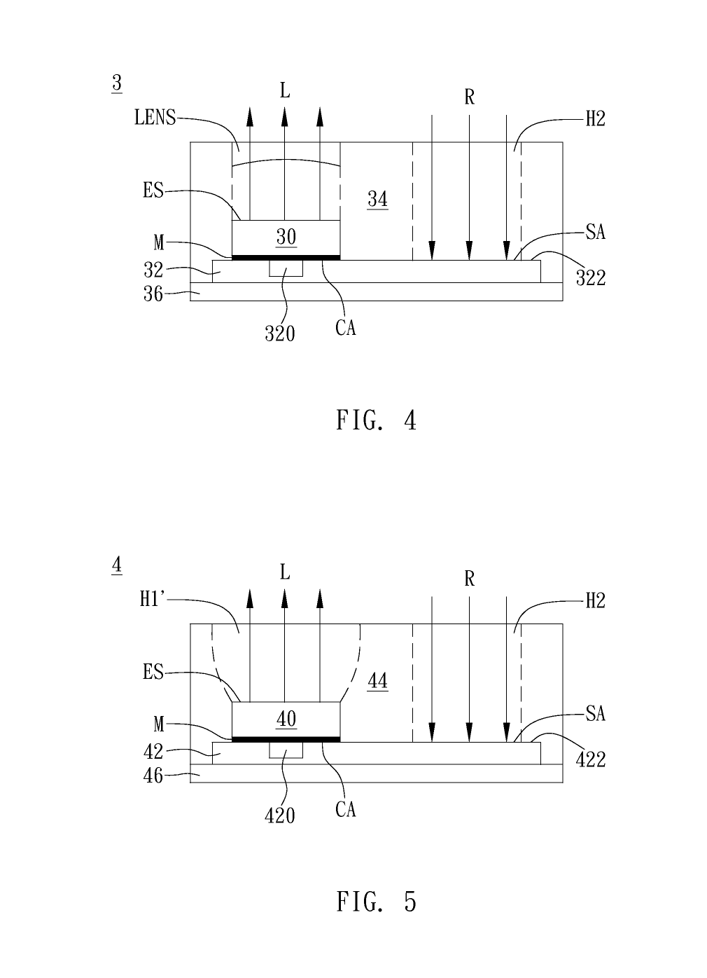

Please refer FIG. 4. FIG. 4 illustrates a cross-sectional schematic diagram of the proximity sensor package 3 further including a lens set LENS. As shown in FIG. 4, the lens set LENS is disposed above the light emitting unit 30. The functions of the lens set LENS in this embodiment is that when the lights L of the light emitting unit 30 is emitted out through the first hole H1, the lights L will be focused by the lens set LENS to be far away from the light sensing area SA on the light sensor 32. Therefore, the lights L will be harder to be refracted to the light sensing area SA on the light sensor 32 to prevent the misjudgment by the light sensor 32.

Please refer to FIG. 5. FIG. 5 illustrates a cross-sectional schematic diagram of the proximity sensor package 4 further including a curved hole structure H1′. As shown in FIG. 5, the curved hole structure H1′ is disposed above the light emitting unit 40. The functions of the curved hole structure H1′ in this embodiment is that when the lights L of the light emitting unit 40 is emitted out through the curved hole structure H1′, the lights L will be harder to be refracted into the packaging molding compound 44; therefore, the lights L refracted to the light sensing area SA on the light sensor 42 can be reduced to prevent the misjudgment by the light sensor 42.

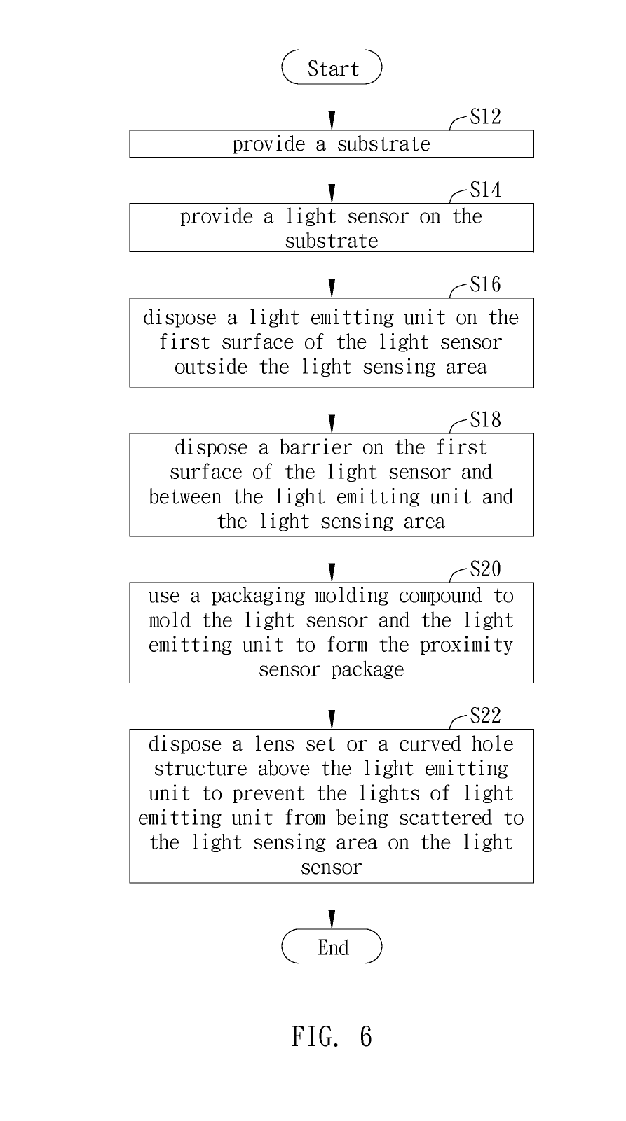

Another preferred embodiment of the invention is a packaging method for a proximity sensor package. In this embodiment, the packaging method is used to package a proximity sensor package. Please refer to FIG. 6. FIG. 6 illustrates a flowchart of the packaging method for the proximity sensor package in this embodiment.

As shown in FIG. 6, in the step S12, the method provides a substrate. In the step S14, the method provides a light sensor on the substrate, and a first surface (the upper surface) of the light sensor has a light sensing area. In the step S16, the method disposes a light emitting unit on the first surface of the light sensor outside the light sensing area. This will make the light emitting surface of the light emitting unit and the light sensing area on the light sensor located on different planes respectively, and the barrier is disposed between the light emitting unit and the light sensing area to effectively prevent the cross-talk generated by scattering the lights of the light emitting unit to the light sensing area on the light sensor.

In practical applications, there is an adhering area on the first surface of the light sensor, and the light emitting unit is disposed on the adhering area. A pin of the light emitting unit can be electrically connected with a control circuit of the light sensor through a metal layer of the adhering area. The control circuit of the light sensor is used to control the operation of the light sensor and the light emitting unit. In fact, the metal layer on the adhering area of the first surface of the light sensor can be formed using a specific layout method, such as the auto place and route (APR) method usually used in the circuit layout field, but not limited to this.

In the step S20, the method uses a packaging molding compound (e.g., a light-blocking material, but not limited to this) to mold the light sensor and the light emitting unit to form the proximity sensor package.

In practical applications, before the step S20, the method can perform the step S18 to dispose a barrier on the first surface of the light sensor and between the light emitting unit and the light sensing area. It should be noticed that the aim of disposing the barrier between the light emitting unit and the light sensing area is to (1) prevent the cross-talk generated by scattering the lights of the light emitting unit to the light sensing area on the light sensor; and (2) separate the glue molding on the light emitting unit and the glue molding on the light sensing area to prevent the connection between them which might result in misjudgment by the light sensor.

In addition, the method can also perform the step S22 to dispose a lens set or a curved hole structure above the light emitting unit to prevent the lights of the light emitting unit from being scattered to the light sensing area on the light sensor.

Compared to the prior arts, in the proximity sensor package and packaging method thereof of the invention, a metal layer is disposed on the upper surface of the light sensor, so that the pin of the light emitting unit can be electrically connected to the control circuit through the metal layer to effectively reduce the volume of the entire proximity sensor package. In addition, since the light emitting surface of the light emitting unit and the light sensing area on the light sensor are located on different planes respectively, and furthermore a barrier is disposed between the light emitting unit and the light sensing area, the cross-talk generated by scattering the lights of the light emitting unit to the light sensing area on the light sensor can be effectively prevented, so that the proximity sensor will not malfunction due to misjudgment.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A proximity sensor package, comprising:
a light sensor having a first surface, and the first surface having a light sensing area; and
a light emitting unit disposed on the first surface of the light sensor outside the light sensing area.

2. The proximity sensor package of claim 1, further comprising:
a barrier, disposed on the first surface and between the light emitting unit and the light sensing area.

3. The proximity sensor package of claim 2, wherein the barrier is a die.

4. The proximity sensor package of claim 1, wherein the light emitting unit is disposed on an adhering area of the first surface of the light sensor.

5. The proximity sensor package of claim 4, wherein the light sensor further comprises a control circuit used for controlling the operation of the light sensor and the light emitting unit.

6. The proximity sensor package of claim 4, wherein the light sensor further comprises a control circuit, a pin of the light emitting unit is electrically connected to the control circuit through a metal layer of the adhering area.

7. The proximity sensor package of claim 1, wherein the light sensor and the light emitting unit are dies.

8. The proximity sensor package of claim 1, wherein a lens set or a curved hole structure is disposed above the light emitting unit.

9. The proximity sensor package of claim 1, further comprises:
a molding compound used for molding the light sensor and the light emitting unit to form the proximity sensor package.

10. The proximity sensor package of claim 1, wherein a light emitting surface of the light emitting unit and the light sensing area on the light sensor are located on different planes respectively.

11. A packaging method for a proximity sensor package, comprising steps of:
(a) providing a light sensor, the light sensor having a first surface having a light sensing area; and
(b) disposing a light emitting unit on the first surface of the light sensor outside the light sensing area.

12. The packaging method of claim 11, further comprising the step of:
disposing a barrier on the first surface and between the light emitting unit and the light sensing area.

13. The packaging method of claim 11, wherein there is an adhering area on the first surface of the light sensor, and the light emitting unit is disposed on the adhering area.

14. The packaging method of claim 13, further comprising the step of:
using a control circuit of the light sensor to control the operation of the light sensor and the light emitting unit.

15. The packaging method of claim 13, further comprising the step of:
electrically connecting a pin of the light emitting unit with a control circuit of the light sensor through a metal layer of the adhering area.

16. The packaging method of claim 11, further comprising the step of:
disposing a lens set or a curved hole structure above the light emitting unit.

17. The packaging method of claim 11, further comprising the step of:
using a molding compound to mold the light sensor and the light emitting unit to form the proximity sensor package.

18. The packaging method of claim 11, wherein a light emitting surface of the light emitting unit and the light sensing area on the light sensor are located on different planes respectively.
